(19) United States
(12) Patent Application Publication
(10) Pub. No.: US 2016/0106141 A1
(43) Pub. Date: Apr. 21, 2016

(54) MULTI-FUNCTION MACHINE FOR WASHING FRUITS AND VEGETABLES AND KEEPING THEM FRESH

(71) Applicant: Tsz Lun LIN, KOWLOON (HK)

(72) Inventor: Tsz Lun LIN, KOWLOON (HK)

(21) Appl. No.: 14/565,442

(22) Filed: Dec. 10, 2014

(30) Foreign Application Priority Data
Oct. 17, 2014 (CN) 201410554113.6

(51) Int. Cl. A23N 12/02

(52) U.S. Cl. CPC A23N 12/02

(57) ABSTRACT

Disclosed is a multi-function machine for washing fruits and vegetables and keeping them fresh, which includes a housing having a working basin formed thereinto and a top cover covered on the housing hermetically. The machine further includes an input device disposed on the housing and a holding cavity, in which a washing device, a degradation device, an evacuator and a control circuit are provided, disposed between the housing and the working basin. The control circuit includes a control module and a receiving module, a washing device drive module, a degradation device drive module and an evacuator drive module, all of which are connected with to control module. Under the control of the control circuit, the machine can achieve the functions of washing, degradation and fresh-keeping for the fruits and vegetables so as to make the fruits and vegetables more cleanly and hold the nutritional values thereof.

### BACKGROUND OF THE INVENTION

This present invention claims the benefit of Chinese Patent Application No. CN201410554113.6, filed on Oct. 17, 2014; the contents of which are hereby incorporated by reference.

The present invention relates to household electric appliances and, in particular, it concerns a multi-function machine for washing fruits and vegetables and keeping them fresh.

With the improved quality of life, people pay more and more attention to food safety. In our daily life, there are always pesticide residues, bacterias and insects in the vegetables and fruits on the market, in addition, in order to keep fresh, the skins of some fruits are covered with wax. However, the existing machine for washing fruits and vegetables only can provide the most basic effects of washing by flowing water so that the toxic compounds, such as pesticide residues, cannot be removed from the vegetables or fruits, which will harm human health.

Additionally, people also pay more and more attention to fresh taste of foods and the foods are generally refrigerated by using refrigeration devices such as a refrigerator to prolong the storage time and keep them fresh. However, there has some defects for using refrigerator to keep the foods cool as follows:

1. The refrigerator has higher manufacturing cost, thus it is too expensive for the comsumers who only have requirements of fresh-keeping.

2. When using the refrigerator to keep the foods fresh, its refrigeration unit needs to work all the time which will consuming large energy.

3. The foods, especially fruits and vegetables, keeping fresh by means of cold-storage technology will lose large amounts of water, thereby some nutrients of the foods will be destroyed.

Thus, it is necessary to provide a multi-function machine with functions of washing, disinfection and fresh-keeping for fruits and vegetables.

### BRIEF SUMMARY OF THE INVENTION

One object of the present invention is to provide a multi-function machine with functions of washing, disinfection and fresh-keeping for fruits and vegetables.

To achieve the above object, there is further provided a multi-function machine for washing fruits and vegetables and keeping them fresh, including a housing having a working basin formed thereinto and a top cover covered on the housing hermetically, wherein the machine further includes an input device disposed on the housing for operation of user and a holding cavity 11b, in which a washing device, a degradation device, an evacuator and a control circuit are provided, disposed between the housing and the working basin; the control circuit includes a control module and a receiving module, a washing device drive module, a degradation device drive module and an evacuator drive module, all of which are connected with to control module; the receiving module is connected with the input device for receiving input information from user; the washing device drive module is connected with the washing device for driving the washing device to work so as to achieve a function of washing; the degradation device drive module is connected with the degradation device for driving the degradation device to work so as to achieve a function of degradation; and the evacuator drive module is connected with the evacuator for driving the evacuator so as to achieve a function of fresh-keeping.

Preferably, the washing device includes a water inlet device, a water outlet device and several ultrasonic oscillators; the water inlet device and the water outlet device are connected with a water inlet valve and a water outlet valve both disposed at the bottom of the working basin, respectively, so as to achieve water supply and drainage; and the ultrasonic oscillators are disposed on two lateral walls of the working basin symmetrically so as to make the working basin produce ultrasonic wave.

Preferably, the washing device further includes a water level sensor which is disposed on the lateral wall of the working basin so as to achieve a function of water level automatic detection.

Preferably, the degradation device includes an ozone generator, an gas inlet one-way valve and a delivery pipe connected with the ozone generator and the gas inlet one-way valve, the ozone generator being connected with the degradation device drive module and the gas inlet one-way valve being disposed at the bottom of the working basin.

Preferably, the evacuator comprises an air pump, an gas outlet one-way valve and an exhaust pipe connected with the air pump and the gas outlet one-way valve, the air pump being connected with the evacuator drive module and the gas outlet one-way valve being disposed at the bottom of the working basin.

Preferably, the rear side of the top cover is hinged with the housing, the front side of the top cover has a fastener so as to be buckled with the housing and a seal ring is disposed between the edge of the opening of the working basin and the top cover.

Preferably, the multi-function machine further includes a ventilating device disposed at the central part of the top cover, the ventilating device including a through hole and a sealing plug with which the through hole is plugged hermetically.

Preferably, the input device is a rotary knob which is provided with settings of “washing”, “degradation”, “fresh-keeping”, “automation” and “shut down”; and the input information includes washing trigger signal, degradation trigger signal, fresh-keeping trigger signal, automation trigger signal and shut down control signal.

Preferably, the input device includes several control buttons which includes a “washing” botton, a “degradation” botton, a “fresh-keeping” botton, an “automation” botton and a “shut down” botton; and the input information includes washing trigger signal, degradation trigger signal, fresh-keeping trigger signal, automation trigger signal and shut down control signal.

Preferably, the multi-function machine further includes a display device disposed on the housing for displaying the usage status of the machine and a display drive module connected with the display device and the control module for driving the display device.

Compared with the prior art, the present invention has beneficial effects as follows: under the control of the control circuit 18, the washing device, degradation device and evacuator of the multi-function machine can be driven to achieve functions of washing, degradation and fresh-keeping for the fruits and vegetables in the working basin according to the operations of user. The machine of the present invention can achieve the functions of washing, degradation and fresh-keeping for the fruits and vegetables so as to make the fruits and vegetables more cleanly and hold the nutritional values thereof. It is easy to use and has lower energy consumption, thus it can satisfy the commands of the consumers.

The present invention will become clearer by means of the following description combining the accompanying drawings, which are used to illustrate embodiments of the present invention.

### BRIEF DESCRIPTION OF THE DRAWINGS

FIG. 1 is a block diagram of a multi-function machine according to an embodiment of the present invention;

FIG. 2 is a control principle diagram of the multi-function machine shown in FIG. 1; and

FIG. 3 is a block diagram of a multi-function machine according to another embodiment of the present invention.

### DESCRIPTION OF THE REFERENCE NUMBERS IN THE FIGURES

Multi-function machine 10; housing 11; working basin 11a; holding cavity 11b; top cover 12; fastener 121; ventilating device 122; sealing plug 122a; input device 13; control button 131; display device 14; washing device 15; water inlet device 151; water inlet valve 151a; water outlet device 152; water outlet valve 152a; ultrasonic oscillators 153; water level sensor 154; degradation device 16; ozone generator 161; gas inlet one-way valve 162; delivery pipe 163; evacuator 17; air pump 171; gas outlet one-way valve 172; exhaust pipe 173; control circuit 18; control module 181; receiving module 182; washing device drive module 183; degradation device drive module 184; evacuator drive module 185; display drive module 186; seal ring 19.

### DETAILED DESCRIPTION OF THE INVENTION

The technical solutions of embodiments will be clearly and completely described as follows by combining the figures of the embodiments of the present invention, and similar reference numbers in the figures represent similar components. Obviously, the embodiments described as follows are merely parts of embodiments of the present invention, but not the all. Based on the embodiments of the present invention, other embodiments created by one of ordinary skill in the art without creative work, all belong to the scope of protection of the present invention.

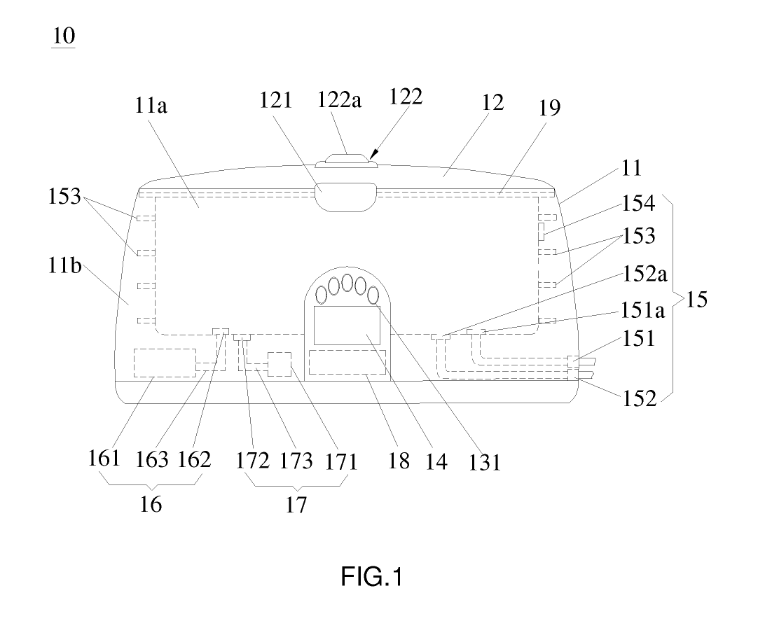

Referring to FIG. 1, it shows an embodiment of the multi-function machine of the present invention. In this embodiment, the multi-function machine 10 includes a housing 11 and a top cover 12 which is covered on the housing 11 hermetically. The machine 10 further includes an input device 13 disposed on the housing 11 for operation of user and a display device 14 also disposed on the housing 11 for showing usage status of the machine 10. A working basin 11a is formed in the housing 11 and a holding cavity 11b is disposed between the housing 11 and the working basin 11a. The machine 10 further includes a washing device 15, a degradation device 16, an evacuator 17 and a control circuit 18, all of which are provided in the holding cavity 11b. The control circuit 18 is connected with the washing device 15, degradation device 16 and evacuator 17 so as to control them to achieve corresponding functionalities.

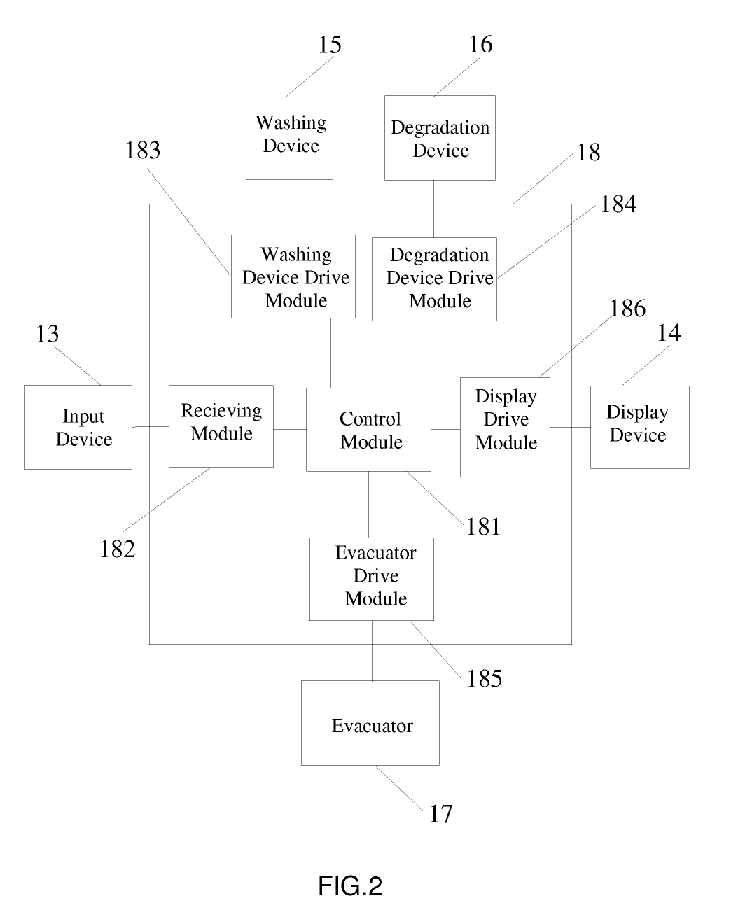

Referring to FIG. 1 and FIG. 2, the detailed structure and function principle of the multi-function machine 10 of the present invention will be described as follows.

In this embodiment, the control circuit 18 includes a control module 181, a receiving module 182, a washing device drive module 183, a degradation device drive module 184, an evacuator drive module 185 and a display drive module 186. The receiving module 182, the washing device drive module 183, the degradation device drive module 184, the evacuator drive module 185 and the display drive module 186 are all connected with and controlled by the control module 181.

In this embodiment, the washing device drive module 183 is connected with the washing device 15 for driving the washing device 15 to work so as to achieve a function of washing. Specifically, the washing device 15 includes a water inlet device 151, a water outlet device 152 and several ultrasonic oscillators 153; the water inlet device 151 and the water outlet device 152 are connected with a water inlet valve 151a and a water outlet valve 152a both disposed at the bottom of the working basin 11a, respectively, so as to achieve water supply and drainage; and the ultrasonic oscillators 153 are disposed on two lateral walls of the working basin 11a symmetrically so as to make the working basin 11a produce ultrasonic wave. In this preferred embodiment, the washing device 15 further includes a water level sensor 154 which is disposed on the lateral wall of the working basin 11a so as to achieve a function of water level automatic detection. When the water in the working basin 11a reaches a preset position, the water inlet device 151 will stop to supply water to the working basin 11a. If the water inlet device 151 is failure, the water outlet device 152 will work to drain so as to keep the water level under the preset position.

In this embodiment, the degradation device 16 includes an ozone generator 161, an gas inlet one-way valve 162 and a delivery pipe 163 connected the ozone generator 161 and the gas inlet one-way valve 162. The ozone generator 161 is connected with the degradation device drive module 184 and the gas inlet one-way valve 162 is disposed at the bottom of the working basin 11a. The degradation device drive module 184 is connected with the degradation device 16 for driving the degradation device 16 to work so as to achieve a function of degradation. When the degradation device drive module 184 is triggered, the ozone generator 161 will produce ozone which will be sent to the working basin 11a by the delivery pipe 163 and gas inlet one-way valve 162, so as to make ozone degradation for fruits and vegetables and achieve a function of disinfection.

In this embodiment, the evacuator 17 includes an air pump 171, an gas outlet one-way valve 172 and an exhaust pipe 173 connected the air pump 171 and the gas outlet one-way valve 172, the air pump 171 being connected with the evacuator drive module 185 and the gas outlet one-way valve 172 being disposed at the bottom of the working basin 11a. When the evacuator drive module 185 is triggered, the air pump 171 will work to make the working basin 11a achieve vacuum state, thus the fruits and vegetables in the working basin 11a will keep fresh by means of such a vacuum state.

In this embodiment, the housing 11 can be covered with the cover 12 hermetically by means of following structure: the rear side of the top cover 12 is hinged with the housing 11, the front side of the top cover 12 has a fastener 121 so as to be buckled with the housing 11 and a seal ring 19 is disposed between the edge of the opening of the working basin 11a and the top cover 12. In this embodiment, to make it convenient for the user to operate it, the multi-function machine 10 further includes a ventilating device 122 disposed at the central part of the top cover 12, the ventilating device 122 including a through hole and a sealing plug 122a with which the through hole is plugged hermetically. When need to remove the foods from the machine 10 which is in a fresh-keeping state, the user can operate the ventilating device 122 to let the air enter into the working basin 11a so that it is easy to open the top cover 12.

In this embodiment, the input device 13 includes several control buttons 131 which includes a “washing” botton, a “degradation” botton, a “fresh-keeping” botton, an “automation” botton and a “shut down” botton. The receiving module 182 is connected with the input device 13 for receiving input information from user and then sending it to the control module 181. In this embodiment, the input informations produced by the “washing” botton, “degradation” botton, “fresh-keeping” botton, “automation” botton and “shut down” botton are washing trigger signal, degradation trigger signal, fresh-keeping trigger signal, automation trigger signal and shut down control signal, respectively. The control module 181 can control the machine 10 to carry out a variety of operations according to a variety of input informations, for example, when the user presses down the “washing” botton, the control module 182 will control the washing device 15 to work so as to achieve a function of washing; and when the user presses down the “automation” botton, the control module 182 will control the machine 10 to achieve a series of operations including washing, degradation and fresh-keeping.

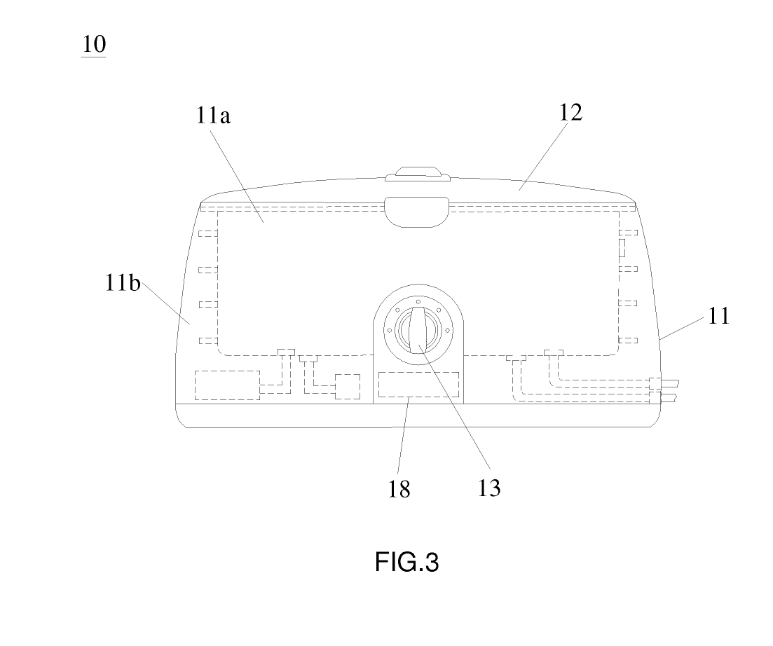

Referring to FIG. 3, it shows another embodiment of the multi-function machine 10 of the present invention. In this embodiment, the input device 13 is a rotary knob which is provided with settings of “washing”, “degradation”, “fresh-keeping”, “automation” and “shut down”; and the input information includes washing trigger signal, degradation trigger signal, fresh-keeping trigger signal, automation trigger signal and shut down control signal.

In conclusion, under the control of the control circuit 18, the washing device 15, degradation device 16 and evacuator 17 of the multi-function machine 10 can be driven to achieve functions of washing, degradation and fresh-keeping, respectively, for the fruits and vegetables in the working basin 11a according to the operations of user. The machine 10 of the present invention can achieve the functions of washing, degradation and fresh-keeping for the fruits and vegetables so as to make the fruits and vegetables more cleanly and hold the nutritional values thereof. It is easy to use and has lower energy consumption, thus it can satisfy the command of the consumers.

It should be noted that the machine 10 of the present invention may include more than one degradation device 16 or the degradation device 16 may include more than one delivery pipe 163 and more than one gas inlet one-way valve 162 to deliver more ozone and make it more uniform. Similarly, the machine 10 of the present invention may include more than one evacuator 17 or the evacuator 17 may include more than one exhaust pipe 173 and more than one gas outlet one-way valve 172 to exhaust more quickly.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

What is claimed is:

1. A multi-function machine for washing fruits and vegetables and keeping them fresh, comprising a housing having a working basin formed thereinto and a top cover covered on the housing hermetically, wherein the machine further comprises an input device disposed on the housing for operation of user and a holding cavity, in which a washing device, a degradation device, an evacuator and a control circuit are provided, disposed between the housing and the working basin; the control circuit comprises a receiving module, a washing device drive module, a degradation device drive module, an evacuator drive module and a control module connected with the receiving module, the washing device drive module, the degradation device drive module and the evacuator drive module; the receiving module is connected with the input device for receiving input information from user; the washing device drive module is connected with the washing device for driving the washing device to work so as to achieve a function of washing; the degradation device drive module is connected with the degradation device for driving the degradation device to work so as to achieve a function of degradation; and the evacuator drive module is connected with the evacuator for driving the evacuator so as to achieve a function of fresh-keeping.

2. The multi-function machine according to claim 1, wherein the washing device comprises a water inlet device, a water outlet device and several ultrasonic oscillators; the water inlet device and the water outlet device are respectively connected with a water inlet valve and a water outlet valve both disposed at the bottom of the working basin, so as to achieve water supply and drainage, respectively; and the ultrasonic oscillators are disposed on two lateral walls of the working basin symmetrically so as to make the working basin produce ultrasonic wave.

3. The multi-function machine according to claim 2, wherein the washing device further comprises a water level sensor which is disposed on the lateral wall of the working basin so as to achieve a function of water level automatic detection.

4. The multi-function machine according to claim 1, wherein the degradation device comprises an ozone generator, an gas inlet one-way valve and a delivery pipe connected with the ozone generator and the gas inlet one-way valve, the ozone generator being connected with the degradation device drive module and the gas inlet one-way valve being disposed at the bottom of the working basin.

5. The multi-function machine according to claim 1, wherein the evacuator comprises an air pump, an gas outlet one-way valve and an exhaust pipe connected with the air pump and the gas outlet one-way valve, the air pump being connected with the evacuator drive module and the gas outlet one-way valve being disposed at the bottom of the working basin.

6. The multi-function machine according to claim 1, wherein the rear side of the top cover is hinged with the housing, the front side of the top cover has a fastener so as to be buckled with the housing and a seal ring is disposed between the edge of the opening of the working basin and the top cover.

7. The multi-function machine according to claim 1, wherein further comprises a ventilating device disposed at the central part of the top cover, the ventilating device comprising a through hole and a sealing plug with which the through hole is plugged hermetically.

8. The multi-function machine according to claim 1, wherein the input device is a rotary knob which is provided with settings of “washing”, “degradation”, “fresh-keeping”, “automation” and “shut down”; and the input information comprises washing trigger signal, degradation trigger signal, fresh-keeping trigger signal, automation trigger signal and shut down control signal.

9. The multi-function machine according to claim 1, wherein the input device comprises several control buttons which comprises a “washing” botton, a “degradation” botton, a “fresh-keeping” botton, an “automation” botton and a “shut down” botton; and the input information comprises washing trigger signal, degradation trigger signal, fresh-keeping trigger signal, automation trigger signal and shut down control signal.

10. The multi-function machine according to claim 1, wherein further comprises a display device disposed on the housing for displaying the usage status of the machine and a display drive module connected with the display device and the control module for driving the display device.
